(19) United States
(12) Patent Application Publication
(10) Pub. No.: US 2010/0009695 A1
(43) Pub. Date: Jan. 14, 2010

(54) COMMUNICATION SYSTEM TO PERFORM LENDING AND/OR BORROWING OF A RADIO RESOURCE

(76) Inventors: Tae Soo KWON, Hwaseong-si (KR); Hyo Sun HWANG, Seoul (KR); Ohyun JO, Cheongju-si (KR); Woongsup LEE, Daejeon (KR); Ki Song LEE, Hwaseong-si (KR); Dong Ho CHO, Seoul (KR)

Correspondence Address: North Star Intellectual Property Law, PC, P.O. Box 34688, Washington DC, DC, 20043, US

(21) Appl. No.: 12/393,659

(22) Filed: Feb. 26, 2009

(30) Foreign Application Priority Data
Jul. 8, 2008 (KR) 10-2008-0066083

(51) Int. Cl. H04W 72/08; H04W 72/04

(52) U.S. Cl. 455/452.2; 455/450

(57) ABSTRACT

A wireless communication system, and more particularly, a base station apparatus to lend an idle resource to another base station or to borrow an idle resource from another base station is provided. A borrowing base station apparatus includes a transmitter to transmit an idle resource borrowing message to a lending base station, and a receiver to receive, from the lending base station in response to the idle resource borrowing message, an idle resource lending message including information regarding whether to lend an idle resource of the lending base station, such that the transmitter transmits data to a terminal using the idle resource. The borrowing base station may borrow an idle resource from the lending base station to use the borrowed idle resource to perform data transmission.

### CROSS-REFERENCE TO RELATED APPLICATION

This application claims the benefit under 35 U.S.C. §119(a) of a Korean Patent Application No. 10-2008-0066083, filed on Jul. 8, 2008, in the Korean Intellectual Property Office, the entire disclosure of which is incorporated herein by reference.

### BACKGROUND

1. Field

The following description relates to a wireless communication system, and more particularly, to a base station apparatus to perform lending of an idle resource to another base station or borrowing an idle resource from another base station.

2. Description of the Related Art

A conventional wireless communication system includes a plurality of base stations. Terminals transmitting data via the wireless communication system may select any one base station from the plurality of base stations included in the wireless communication system to connect to the selected base station. Radio resources may be assigned to each of the base stations and each base station may transmit the data using the assigned radio resources.

The base stations may transmit data to the connected terminals. Generally, each of the base stations may transmit a different amount of data. A base station transmitting a large amount of data may consume a large amount of radio resources. Since an amount of the assigned radio resources is limited, the amount of data that can be transmittable by each of the base stations may be determined based on the assigned radio resources.

A particular base station may transmit large amounts of data to a terminal and another base station adjacent to the particular base station may transmit only small amounts of data to the terminal. Even in a case where the particular base station cannot transmit more data to the terminal due to lack of radio resource, the other base station adjacent to the particular base station may transmit data to the terminal using only a portion of radio resources.

According to related art, even in a case where the particular case is short of available radio resource, the particular base station may not use radio resource that is not used by the adjacent base station. Specifically, each base station is allowed to use only an initially assigned radio resource. Accordingly, where a data transmission rate corresponding to each base station is significantly different, it may be difficult to effectively use radio resource.

### SUMMARY

In one general aspect, there is provided a base station apparatus that enables a borrowing base station to borrow an idle resource from a lending base station to thereby use the idle resource to perform data transmission.

In another general aspect, a borrowing base station apparatus includes a transmitter to transmit an idle resource borrowing message to a lending base station, and a receiver to receive, from the lending base station in response to the idle resource borrowing message, an idle resource lending message including information regarding whether to lend an idle resource of the lending base station, wherein the transmitter transmits data to a terminal using the idle resource.

In still another general aspect, a lending base station apparatus includes a receiver to receive an idle resource borrowing message from a borrowing base station, a lending decision unit to determine whether to lend the borrowing base station idle resource corresponding to the idle resource borrowing message, and a transmitter to transmit an idle resource lending message to the borrowing base station depending on the decision, wherein the borrowing base station transmits data to a terminal using the lent idle resource.

A borrowing base station may borrow an idle resource of a lending base station to use the borrowed idle resource to perform data transmission.

Performance of a wireless communication system may be improved by effectively using radio resource.

Other features will become apparent to those skilled in the art from the following detailed description, which, taken in conjunction with the attached drawings, discloses exemplary embodiments of the present general inventive concept.

### BRIEF DESCRIPTION OF THE DRAWINGS

FIG. 1 is a diagram illustrating an example where a borrowing base station borrows an idle resource from a lending base station with the idle resource according to an exemplary embodiment.

FIG. 2 is a diagram illustrating an example of lending an idle resource in a communication system adopting a time division multiplexing scheme according to an exemplary embodiment.

FIG. 3 is a diagram illustrating an example of lending an idle resource in a communication system adopting a frequency division multiplexing scheme according to an exemplary embodiment.

FIG. 4 is a diagram illustrating an example of assigning a broadcasting channel and a control channel to a lent resource according to an exemplary embodiment.

FIG. 5 is a block diagram illustrating a configuration of a borrowing base station according to an exemplary embodiment.

FIG. 6 is a block diagram illustrating a configuration of a lending base station according to an exemplary embodiment.

FIG. 7 is a flowchart illustrating an operation of a lending base station that transmits idle resource information according to an exemplary embodiment.

FIG. 8 is a flowchart illustrating an operation of a borrowing base station that receives idle resource information according to an exemplary embodiment.

FIG. 9 is a block diagram illustrating a configuration of a terminal that receives, from a borrowing base station, data using a data channel of a lending base station according to an exemplary embodiment.

Throughout the drawings and the detailed description, the same drawing reference numerals will be understood to refer to the same elements, features, and structures.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. Also, description of well-known functions and constructions are omitted to increase clarity and conciseness.

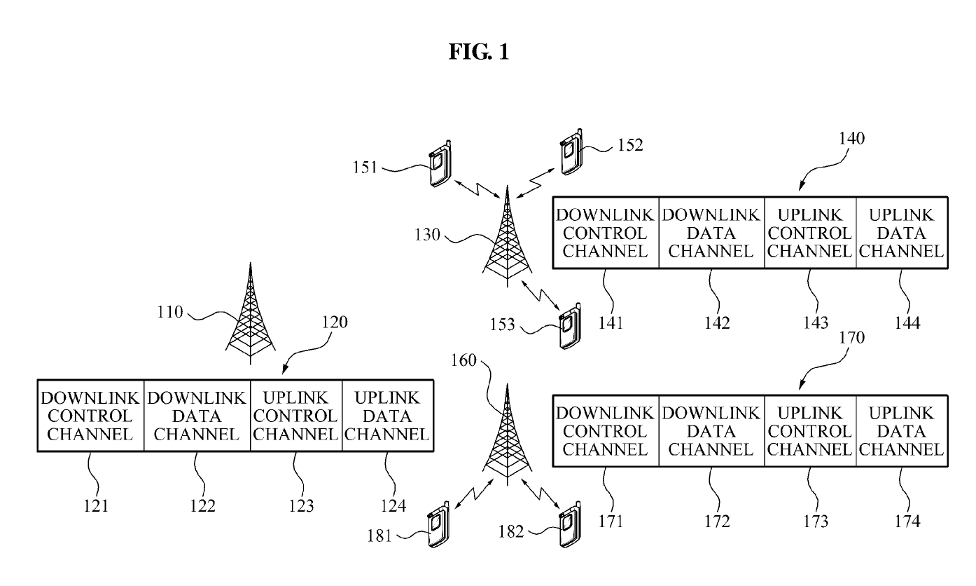

FIG. 1 illustrates an example where a borrowing base station borrows an idle resource from a lending base station with the idle resource according to an exemplary embodiment. Hereinafter, an example where a borrowing base station borrows an idle resource of a lending base station will be described with reference to FIG. 1.

With reference to FIG. 1, a radio resource lending system according to an exemplary embodiment includes a plurality of base stations 110, 130, and 160. The plurality of base stations 110, 130, and 160 may transmit and receive data using data frames 120, 140, and 170 that include downlink control channels 121, 141, and 171, downlink data channels 122, 142, and 172, uplink control channels 123, 143, and 173, and uplink data channels 124, 144, and 174, respectively.

According to an aspect, the base stations 110, 130, and 160 may transmit control signals to be commonly transmitted to terminals 151, 152, and 153 included in the coverage of the base station 130, and terminals 181 and 182 included in the coverage of the base station 160, using the downlink control channels 121, 141, and 171, respectively. Specifically, broadcasting signals and control signals may be transmitted using the downlink control channels 121, 141, and 171. The broadcasting signals denote signals that are periodically transmitted to all the terminals included in the coverage of a base station, and common control signals denote signals that are transmitted to all the terminals included in the coverage of the base station.

According to an aspect, the base stations 110, 130, and 160 may transmit unique signals to the terminals 151, 152, 153, 181, and 182 using the downlink data channels 122, 142, and 172, respectively. Specifically, the base stations 110, 130, and 160 may transmit data that will be received by the terminals 151, 152, 153, 181, and 182, respectively, and also may transmit dedicated control signals that are determined by the terminals 151, 152, 153, 181, and 182, respectively, using the downlink data channels 122, 142, and 172, respectively.

Even in a case where a particular base station does not transmit data to a terminal, each base station may need to periodically transmit a broadcasting signal or a common control signal using its corresponding downlink control channel. Referring to FIG. 1, although the base stations 110, 130, and 160 do not use the downlink data channels 122, 142, and 172, respectively, the downlink control channels may need to be periodically employed.

According to an aspect, the base stations 110, 130, and 160 may receive access signals from the terminals 151, 152, 153, 181, and 182, using the uplink control channels 123, 143, and 173, respectively. The terminals 151, 152, 153, 181, and 182 may transmit the access signals using the uplink control channels 123, 143, and 173, respectively, in order to initially access the radio resource lending system of FIG. 1.

According to an aspect, the base stations 110, 130, and 160 may receive data from the terminals 151, 152, 153, 181, and 182, using the uplink data channels 124, 144, and 174, respectively.

Even in a case where a particular base station does not receive data from a terminal, each base station may need to determine whether there exists any access signal that is received using its corresponding uplink control channel.

Hereinafter, the base station 110 may be referred to as a first base station 110, the base station 130 may be referred to as a second base station 130, and the base station 160 may be referred to as a third base station 160. The first base station 110 may correspond to a lending base station, and the second base station 130 and third base station 160 may correspond to borrowing base stations, respectively. Referring to FIG. 1, the first base station 110 does not transmit data, the second base station 130 transmits data to three terminals 151, 152, and 153, and the third base station 160 transmits data to two terminals 181 and 182. Generally, where an amount of data may be transmitted or received by each of the first, second, and third base stations 110, 130, and 160, respectively, a radio resource amount consumed by each of the first, second, and third base stations 110, 130, and 160, respectively, may also increase.

In FIG. 1, the first base station 110 does not transmit data and thus does not consume radio resources corresponding to the downlink data channel 122 and the uplink data channel 124. According to an aspect, the second base station 130 or the third base station 160 may borrow an idle resource that is not currently being used among radio resources corresponding to the downlink data channel 122 and the uplink data channel 124 of the first base station 110 to thereby use the borrowed idle resource to transmit data to or to receive data from the terminals 151, 152, and 153, or the terminals 181 and 182, respectively.

According to an aspect, where a terminal attempts to access the first base station 110 that has lent the idle resource, the first base station 110 may retrieve the idle resource lent to the second base station 130 or the third base station 160. The first base station 110 may transmit data to the terminal using the retrieved idle resource.

According to an aspect, where a base station transmits large amounts of data and thereby consumes all the assigned radio resources, the base station may use an idle resource of an adjacent base station to perform data transmission. Accordingly, it is possible to effectively use assigned resources of other base stations and improve the performance of the wireless communication system.

According to an aspect, the lending base station 110 may lend the borrowing base stations 130 and 160 only radio resources corresponding to the downlink data channel 122 and the uplink data channel 124, and may not lend radio resources corresponding to the downlink control channel 121 and the uplink control channel 123.

According to an aspect, even in a case where a lending base station lends an idle resource, the lending base station may transmit or receive a control signal. Accordingly, the lending base station may perform all its functions normally with the exception of transmitting or receiving data using the lent radio resource. The lending base station may transmit a common control signal to terminals included in the coverage of the lending base station using a downlink control channel, or may receive an access signal using an uplink control channel. Where the lending base station receives the access signal from a terminal using the uplink control channel, the lending base station may retrieve a downlink data channel lent to a borrowing base station, and transmit data to the terminal that has transmitted the access signal, using the retrieved downlink data channel. Also, the lending base station may retrieve an uplink data channel lent to the borrowing base station, and receive data from the terminal that has transmitted the access signal, using the retrieved uplink data channel.

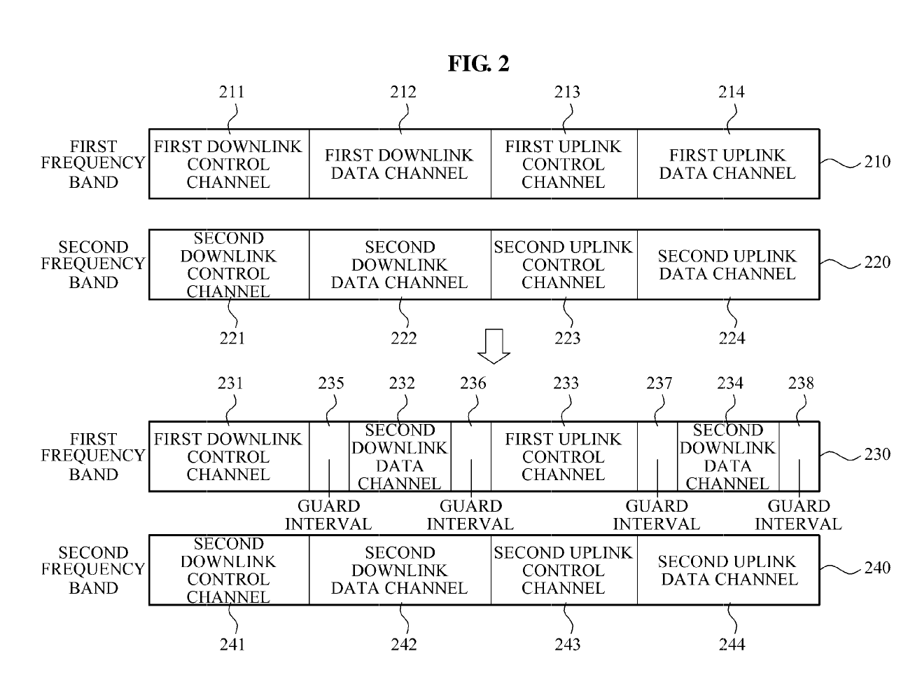

FIG. 2 illustrates an exemplary embodiment of lending an idle resource in a communication system adopting a time division multiplexing scheme. Hereinafter, the example of lending an idle resource in the communication system will be described with reference to FIG. 2.

Referring to FIGS. 1 and 2, the first base station 110 is assigned with a first frequency band 210 and the second base station 130 is assigned with a second frequency band 220. The first base station 110 may use a data frame that includes a first downlink control channel 211, a first downlink data channel 212, a first uplink control channel 213, and a first uplink data channel 214. The second base station 130 may use a data frame that includes a second downlink control channel 221, a second downlink data channel 222, a second uplink control channel 223, and a second uplink data channel 224. The first base station 110 and the second base station 130 may transmit broadcasting information and a common control signal that are used when a terminal accesses a base station, using the first downlink control channel 211 and the second downlink control channel 221, respectively. Although no data is transmitted from a base station to the terminal or no data is received from the terminal, the broadcasting information and the common control signal may need to be transmitted.

The first base station 110 and the second base station 130 may receive the common control signal from the terminal using the first uplink control channel 213 and the second uplink control channel 223, respectively. According to an aspect, a common control signal that is received by each base station may include an access signal that the terminal transmits to access the wireless communication system.

The first base station 110 and the second base station 130 may transmit data to the terminal using the first downlink data channel 212 and the second downlink data channel 222, respectively, and may also receive data from the terminal using the first uplink data channel 214 and the second uplink data channel 224, respectively.

In FIG. 2, it is assumed that the first base station 110 does not use radio resources corresponding to the first downlink data channel 212 and the first uplink data channel 214, and the second base station 130 uses all the radio resources corresponding to the second downlink data channel 222 and the second uplink data channel 224. The second base station 130 may borrow an idle resource that is not used by the first base station 110 to thereby use the idle resource to transmit and receive data.

According to an aspect, the first base station 110 may lend the second base station 130 radio resources corresponding to the first downlink data channel 212 and the first uplink data channel 214. Accordingly, even in a case where the second base station 130 uses an idle resource of the first base station 110, the first base station 110 may transmit broadcasting information and a common control signal using a first downlink control channel 231. Also, the first base station 110 may receive a common control signal from a terminal included in the coverage of the first base station 110 using a first uplink control channel 233.

The second base station 130 may transmit data to a terminal using second downlink data channels 232 and 242. The second base station 130 may generate the second downlink data channel 242 in a second frequency band 240 assigned to the second base station 130 to thereby transmit data. Also, the second base station 130 may generate the second downlink data channel 232 in a frequency band 230 assigned to the first base station 110 to thereby transmit data.

Also, the second base station 130 may generate a second uplink data channel 244 in the second frequency band 240 to thereby receive data from the terminal and may also generate a second downlink data channel 234 in the first frequency band 230 to thereby receive data from the terminal.

The first frequency band 210 is a radio resource assigned to the first base station 110. Therefore, if a terminal attempts to access the first base station 110 to transmit data, the second base station 130 may need to return the first frequency band 210 to the first base station 110.

According to an aspect, the first base station 110 may use the first uplink control channel 233 in order to receive an access signal from the terminal. Even in a case where the first base station 110 has lent an idle resource to the second base station 130, the first base station 110 may still use radio resource corresponding to the first uplink control channel 233. Accordingly, a terminal that attempts to transmit data to the first base station 110 may transmit an access signal to the first base station 110 using the first uplink control channel 233.

The first base station 110 may retrieve an idle resource lent to the second base station 130 to thereby transmit data to the terminal, or may receive data from the terminal using the retrieved radio resource.

According to an aspect, the first base station 110 and the second base station 130 may not be synchronized with each other. In this case, a starting point in time of a data frame where the first base station 110 transmits data may be different from a starting point in time of a data frame where the second base station 130 transmits data. Where the first base station 110 and the second base station 130 are not synchronized with each other, the first downlink control channel 231 of the first base station 110 may collide with the second downlink data channel 232 of the second base station 130.

According to an aspect, where the first base station 110 and the second base station 130 are not synchronized with each other, a guard interval 235 may be inserted between the first downlink control channel 231 and the second downlink data channel 232 in order to prevent collision therebetween. Also, additional guard intervals 236, 237, and 238 may be provided in order to prevent collision between the second downlink data channel 232, the first uplink control channel 233, and the second downlink data channel 234, respectively.

Where the first base station 110 and the second base station 130 are synchronized with each other, there is no collision probability between a channel of the first base station 110 and a channel of the second base station 130. Accordingly, the guard intervals 235, 236, 237, and 238 may not be required.

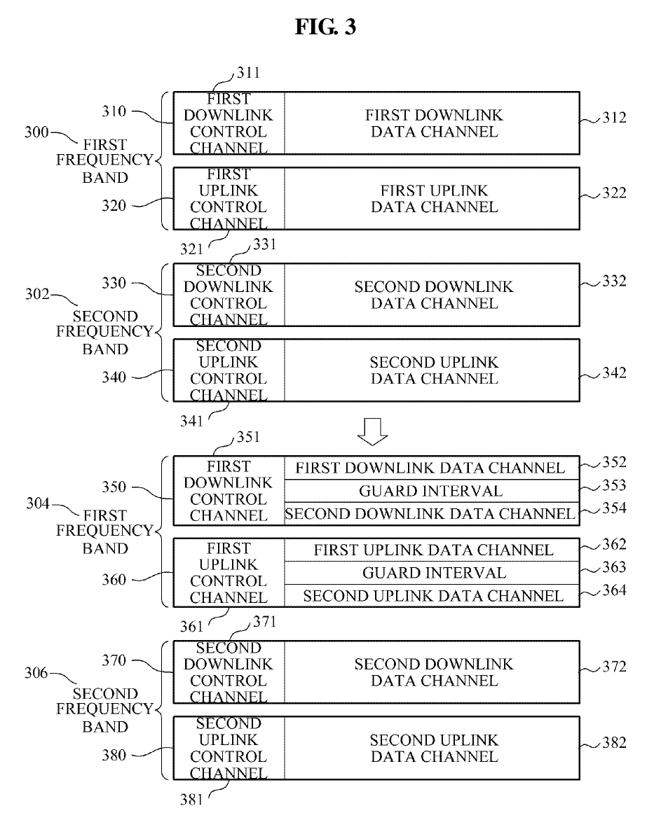

FIG. 3 illustrates an exemplary embodiment of lending an idle resource in a communication system adopting a frequency division multiplexing scheme. Hereinafter, the example of lending the idle resource in the communication system will be described with reference to FIG. 3.

Referring to FIGS. 1 and 3, the first base station 110 is assigned with a first frequency band 300 and the second base station 130 is assigned with a second frequency band 302. The first frequency band 300 may be divided into a downlink frequency band 310 and an uplink frequency band 320. The second frequency band 302 may be divided into a downlink frequency band 330 and an uplink frequency band 340.

The first base station 110 may transmit broadcasting information and a control signal using a first downlink control channel 311 that is included in the downlink frequency band 310 of the first frequency band 300. Here, the transmitted control signal may be a common control signal that is transmitted to all the terminals included in the coverage of the first base station 110. The first base station 110 may transmit data to a first terminal using a first downlink data channel 312 included in the downlink frequency band 310 of the first frequency band 300. The first base station 110 may receive the control signal from the terminal using a first uplink control channel 321 included in the uplink frequency band 320 of the first frequency band 300. According to an aspect, the control signal that is received by the first base station 110 from the first terminal may include an access signal that is transmitted from the first terminal to access the wireless communication system.

Also, the first base station 110 may receive data from a terminal using the first uplink data channel 322 that is included in the uplink frequency band 320 of the first frequency band 300.

Using the similar scheme, the second base station 130 may also transmit broadcasting information, a common control signal, and data using the downlink frequency band 330 of the second frequency band 302. Also, the second base station 130 may receive the control signal and the data using the uplink frequency band 340 of the second frequency band 302.

In FIG. 3, it is assumed that the second base station 130 transmits a large amount of data and thereby is short of radio resources and a radio resource of the first base station 110 still remains. The second base station 130 short of radio resources may borrow the radio resource of the first base station 110 to thereby transmit or receive data.

The second base station 130 may transmit broadcasting information and a common control signal using a second downlink control channel 371 included in a downlink frequency band 370 of a second frequency band 306. The second base station 130 may transmit data to a second terminal using a second downlink data channel 372 included in the downlink frequency band 370 of the second frequency band 306. The second base station 130 may borrow a second downlink data channel 354 included in a downlink frequency band 350 of a first frequency band 304 to transmit data to the second terminal using the second downlink data channel 354.

The second base station 130 may receive an access signal from a second terminal using a second uplink control channel 381 included in an uplink frequency band 380 of the second frequency band 306. The second base station 130 may receive data from the second terminal using a second uplink data channel 382 included in the uplink frequency band 380 of the second frequency band 306. Also, the second base station 130 may borrow an uplink data channel 364 included in an uplink frequency band 360 of the first frequency band 304 to thereby receive data from the second terminal using the uplink data channel 364.

The first base station 110 may not transmit or receive data using radio resource lent to the second base station.

According to an aspect, the first base station 110 may not lend the second base station 130 radio resources corresponding to a first downlink control channel 351 and a first uplink control channel 361 that are used to transmit broadcasting information and a common control signal, or to receive an access signal from another terminal. The first base station 110 may lend the second base station 130 an idle resource that is not currently used by the first base station 110 among radio resources used to transmit or receive data.

FIG. 3 illustrates an example where the first base station 110 lends the second base station 130 only a portion of radio resources that are used to transmit or receive data. This is only exemplary and embodiments consistent with teachings herein are not limited thereto. For example, the first base station 110 may lend the second base station 130 all the radio resources to transmit or receive data.

Where more radio resources are required since a data transmission rate or an amount of received data increases in the first base station 110, the first base station 110 may retrieve the radio resource lent to the second base station 130 to thereby transmit or receive data using the retrieved radio resource.

Where the first base station 110 and the second base station 130 are not synchronized with each other, data transmitted from the first base station 110 may collide with data transmitted from the second base station 130. According to an aspect, a guard interval 353 may be inserted between a first downlink data channel 352 of the first base station 110 and a second downlink data channel 354 of the second base station 130 in order to prevent collision therebetween.

A guard interval 363 may be inserted between a first uplink data channel 362 of the lending base station and a second uplink data channel 364 of the borrowing base station in order to prevent collision therebetween.

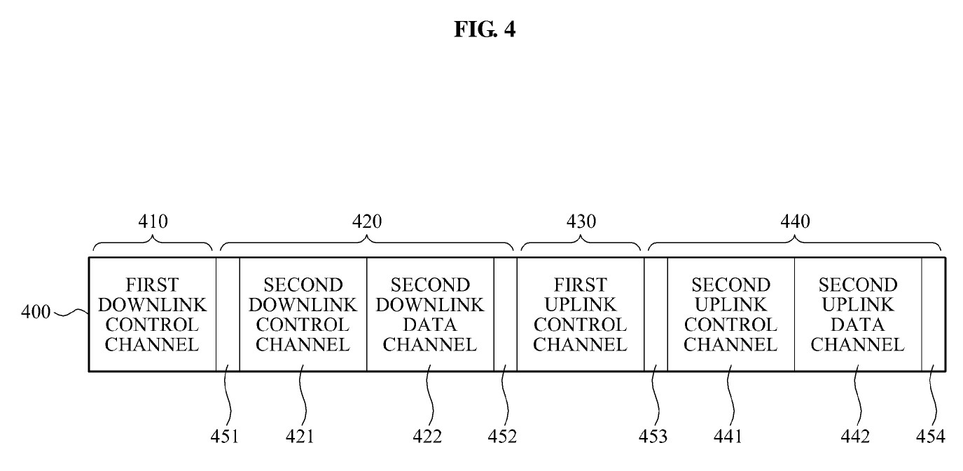

FIG. 4 illustrates an exemplary embodiment of assigning a broadcasting channel and a control channel to a lent resource. Hereinafter, the example of assigning the broadcasting channel and the control channel to the lent resource and transmitting broadcasting information or a common control signal to a terminal using the assigned channel will be described with reference to FIG. 4.

Referring to FIG. 4, a second base station 130 may borrow a radio resource assigned to a first base station 110 to thereby transmit and receive data using the borrowed radio resource. Here, a base station 110 may transmit data using the time division multiplexing scheme in a similar manner to the scheme described with reference to FIG. 2. According to an aspect, the first base station 110 may maintain a first downlink control channel 400 in the assigned radio resource and transmit broadcasting information and a common control signal.

According to an aspect, adjacent cognitive wireless communication apparatuses may lend or borrow assigned radio resource to perform data transmission. The assigned radio resource of the cognitive wireless communication apparatuses may be a broadband bandwidth. Where a terminal transmitting data to and receiving data from a cognitive wireless communication apparatus may use only a portion of frequency bands assigned to the cognitive wireless communication apparatus, the terminal may not communicate with a base station lending a radio resource.

Specifically, in order to communicate with the second base station 130 when it borrows a radio resource, the terminal may receive broadcasting information and the common control signal using a second broadcasting channel and a second control channel 421 that are initially assigned to the second base station 130. The terminal may need to transmit or receive data using a second downlink data channel 422 and a second uplink data channel 442 that are respectively generated in radio resources 420 and 440 borrowed by the second base station 130. However, terminals that can use only a portion of frequency bands may not receive two frequency bands and thus may not communicate with a base station.

According to an aspect, the second base station 130 may generate a second downlink control channel 421 in the radio resource 420 borrowed from the first base station 110 and transmit the broadcasting signal and the common control signal to the terminal.

According to an aspect, the second base station 130 may exchange a control signal with the terminal using the second downlink control channel 421 and a second uplink control channel 441. Also, the second base station 130 may transmit data to or receive data from the terminal using the second downlink data channel 422 and the second uplink data channel 442.

According to an aspect as illustrated in FIG. 4, a terminal receiving data from the second base station 130 may receive broadcasting information or a common control signal using the second downlink control channel 421 that is generated in the frequency band 420 borrowed by the second base station 130 from the first base station 110, and may receive data using the second downlink data channel 422 that is generated in the frequency band 420 borrowed by the second base station 130 from the first base station 110.

According to another aspect, a terminal receiving data from the second base station 130 may receive broadcasting information or a common control signal using a second downlink control channel that is generated in an initially assigned frequency band of the second base station 130, and may receive or transmit data using the second downlink data channel 422 and the second uplink data channel 442 that are generated in the radio resource borrowed from the first base station 110.

FIG. 4 illustrates an example where only the second base station 130 borrows an idle resource of the first base station 110. This is only exemplary and embodiments consistent with teachings herein are not limited thereto. For example, a plurality of borrowing base stations may borrow an idle resource of the first base station 110. Where the plurality of borrowing base stations borrows the idle resource of the first base station 110, the plurality of borrowing base stations may perform time division or frequency division of the idle resource to thereby use the borrowed idle resource as a radio resource.

According to an aspect, where the first base station 110 and the second lending base station 130 are not synchronized with each other, at least one of guard intervals 451, 452, 453, and 454 may be provided in order to prevent collision among channels 410 and 430 of the first base station 110 and channels 421, 422, 441, and 442 of the second base station 130. According to another aspect, the first base station 110 and the second base station 130 may be synchronized with each other. In this case, a guard interval may not be used.

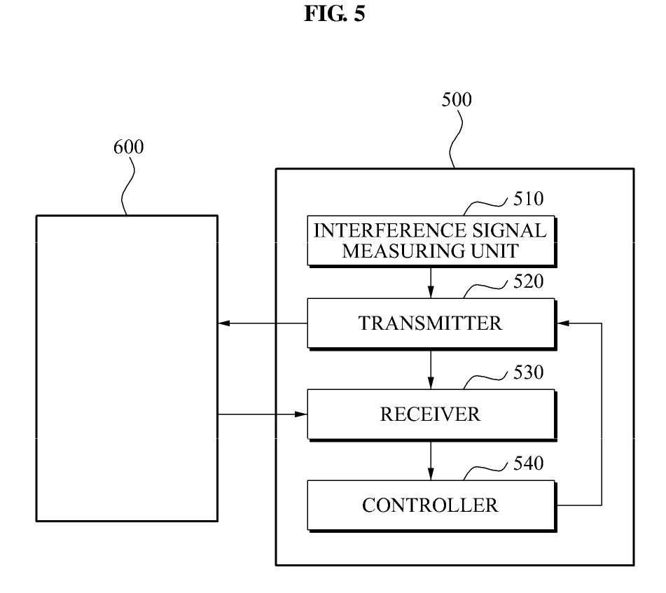

FIG. 5 illustrates a block diagram illustrating an exemplary a configuration of a borrowing base station 500 according to an exemplary embodiment. Hereinafter, an operation of the borrowing base station 500 will be described with reference to FIG. 5. The borrowing base station 500 includes an interference signal measuring unit 510, a transmitter 520, a receiver 530, and a controller 540.

The transmitter 520 may transmit an idle resource borrowing message to a lending base station 600. According to an aspect, the idle resource denotes a radio resource that is assigned to the lending base station 600, is not currently used by the lending base station 600, and is not lent to the borrowing base station 500. Specifically, the idle resource may include at least one of a frequency band of a data channel of the lending base station 600, a time slot thereof, and an extension code number thereof.

The lending base station 600 may transmit an idle resource lending message in response to the idle resource borrowing message. The receiver 530 may receive the idle resource lending message. The idle resource lending message may include information regarding whether to allow lending of the idle resource of the lending base station 600.

Where the receiver 530 receives the idle resource lending message including information regarding that the lending base station 600 lends the idle resource to the borrowing base station, the transmitter 520 may transmit data to a terminal using the idle resource of the lending base station 600.

According to an aspect, the receiver 530 may receive idle resource information from the lending base station 600. The controller 540 may determine whether to borrow the idle resource of the lending base station 600 based on the idle resource information. The idle resource information may include information regarding which radio resource among radio resources corresponding to a data channel of the lending base station 600 is an idle resource. Where the controller 540 determines to borrow the idle resource of the lending base station 600, the transmitter 520 may transmit the idle resource borrowing message to the lending base station 600.

According to another aspect, the receiver 530 may receive a base station signal from the lending base station 600. The controller 540 may sense the base station signal to determine the idle resource of the lending base station 600. The base station signal may include a control channel and a data channel.

According to an aspect, where the controller 540 does not detect a downlink control channel of the lending base station 600, the controller 540 may determine a radio resource corresponding to a base station signal as an idle resource. The downlink control channel of the lending base station 600 may be used to transmit a downlink common control signal and broadcasting information. The downlink common control signal and broadcasting information may need to be received at all times by terminals positioned in the coverage of the borrowing base station 600. Accordingly, even in a case where the lending base station 600 does not have data to be transmitted or received, the lending base station 600 may need to transmit the downlink common control signal and broadcasting information.

Accordingly, if the controller 540 does not detect the downlink control channel of the lending base station 600 as a result of sensing a particular frequency band, it may be determined the lending base station 600 does not use the particular frequency band. The controller 540 may determine a radio resource corresponding to the particular frequency band as an idle resource.

Also, if the controller 540 detects the downlink control channel of the lending base station 600 as the result of sensing the particular frequency band, the controller 540 may sense an additional downlink data channel of the lending base station 600. If the controller 540 does not sense the downlink data channel of the lending base station 600, the controller 540 may determine a radio resource corresponding to the downlink data channel of the particular frequency band as an idle resource.

According to an aspect, the borrowing base station 500 may initially sense the downlink control channel of the lending base station 600 to thereby quickly determine whether the lending base station 600 is currently using the particular frequency band.

According to an aspect, a radio resource borrowing message may be received from a plurality of borrowing base stations 500 with respect to limited idle resources of the lending base station 600. Also, the lending base station 600 may only lend a portion of an idle resource to each of the plurality of borrowing base stations 500 based on the radio resource borrowing message received from the plurality of borrowing base stations 500.

According to the embodiment of FIG. 5, the interference signal measuring unit 510 may measure a strength of interference signal with respect to the idle resource. The transmitter 520 may transmit, to the lending base station 600, an amount of data to be transmitted to a terminal and the measured strength of the interference signal. An idle resource lending message may be generated based on the amount of transmitted data and the strength of transmitted interference signal.

The lending base station 600 may determine an amount of idle resources to be lent to each borrowing base station 500 based on an amount of interference signal and an amount of data that is transmitted from each borrowing base station 500 to the lending base station 600.

Where data transmission of the borrowing base station 500 using the borrowed radio resource is completed, or where the lending base station 600 requires the lent radio resource in order to transmit and receive data, the borrowing base station 500 may return the radio resource to the lending base station 600.

According to an aspect, the receiver 530 may receive, from the lending base station 600, an idle resource lending terminating message with respect to an idle resource. The transmitter 520 may suspend data transmission using the idle resource according to the idle resource lending terminating message.

According to an aspect, the borrowing base station 500 may transmit non-real time data using the borrowed radio resource. The borrowed radio resource may need to be returned to the lending base station 600 upon the request thereof. Where returning the radio resource, the borrowing base station 500 may need to suspend data transmission using the borrowed radio resource and may need to convert to data transmission using only originally assigned radio resources of the borrowing base station 500. Since time latency may occur as a result of the converting process, the borrowing base station 500 may transmit only the non-real time data using the borrowed radio resource.

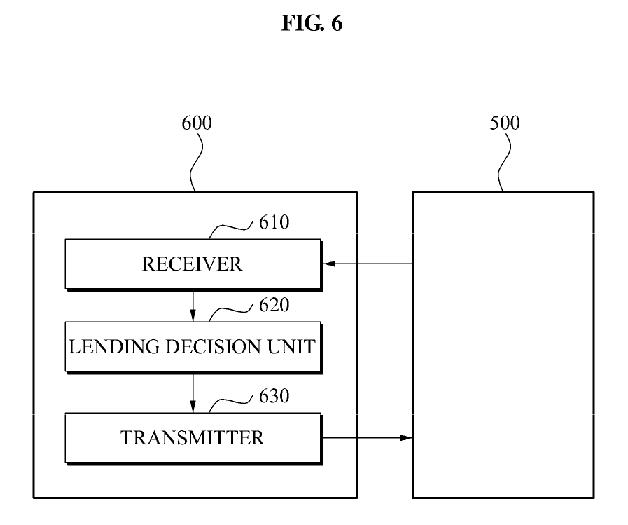

FIG. 6 illustrates an exemplary configuration of a lending base station 600. Hereinafter, an operation of the lending base station 600 will be described with reference to FIG. 6 accordingly to an exemplary embodiment. The lending base station 600 includes a receiver 610, a lending decision unit 620, and a transmitter 630.

The receiver 610 may receive an idle resource lending message from the borrowing base station 500. According to an aspect, the idle resource may denote a radio resource that is assigned to the lending base station 600, is not currently used by the lending base station 600, and is not lent to the borrowing base station 500.

Specifically, the idle resource may include at least one of a frequency band of a data channel of the lending base station 600, a time slot thereof, and an extension code number thereof.

According to an aspect, the transmitter 630 may transmit idle resource information to the borrowing base station 500. The borrowing base station 500 may select, from idle resources of the lending base station 600, a radio resource to borrow. An idle resource borrowing message may include information associated with the selected radio resource. Specifically, the idle resource borrowing message may be generated based on the idle resource information transmitted from the transmitter 630.

According to another aspect, the transmitter 630 may transmit a base station signal to the borrowing base station 500. The borrowing base station 500 may sense the base station signal to thereby generate idle resource information of the lending base station 600. Accordingly, the idle resource borrowing message may be generated by sensing the base station signal.

The lending decision unit 620 may determine whether to lend the idle resource to the borrowing base station 500 based on the idle resource borrowing message.

According to an aspect, the receiver 610 may receive information regarding an amount of interference signal with respect to an idle resource and an amount of data to be transmitted from the borrowing base station 500 to a terminal. The lending decision unit 630 may determine whether to lend the idle resource to the borrowing base station 500 based on the amount of interference signal and the amount of data.

Depending on the decision of the lending decision unit 620, the transmitter 630 may transmit the idle resource lending message to the lending base station 600 and the borrowing base station 500 may transmit data to the terminal using the lent idle resource.

According to an aspect, the plurality of borrowing base stations 500 may request the lending base station 600 to lend a radio resource of the lending base station 600. The receiver 610 may receive, from each borrowing base station 500, information regarding an amount of interference signal and an amount of data to be transmitted. The lending decision unit 620 may assign an idle resource based on the received amount of interference signal and the amount of data. According to an aspect, the lending decision unit 620 may lend an idle resource to each borrowing base station 500 in proportion to the amount of data transmitted from the lending base station 600 to the terminal and in inverse proportion to the amount of interference signal.

Where the receiver 610 receives an access signal from a terminal that is positioned in the coverage of the lending base station 600, the lending base station 600 may require radio resource in order to transmit data to the terminal. The lending base station 600 may retrieve radio resource lent to the borrowing base station 500 and transmit data to the terminal using the retrieved radio resource.

According to an aspect, the transmitter 630 may transmit, to the borrowing base station 500, the idle resource lending terminating message and transmit data to the terminal using the retrieved idle resource.

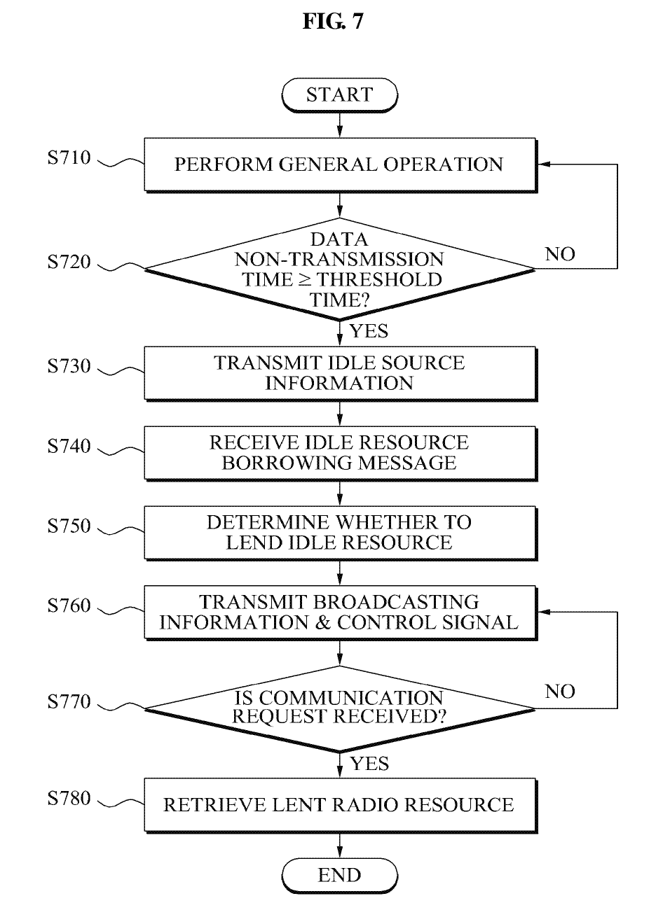

FIG. 7 illustrates an operation of a lending base station that transmits idle resource information according to an exemplary embodiment. Hereinafter, an operation of the lending base station 600 of FIGS. 5 and 6 will be described with reference to FIG. 7.

In operation S710, the lending base station 600 may perform a general operation.

In operation S720, the lending base station 600 may determine whether there exists an idle resource that is not used to perform data transmission or is not lent to the borrowing base station 500 among radio resources of the lending base station 600. According to an aspect, the lending base station 600 may determine, as the idle resource, a radio resource that is not used to transmit data to the terminal for greater than or equal to a predetermined threshold time.

In operation S730, the lending base station 600 may transmit idle resource information to the borrowing base station 500. The idle resource information may include information associated with a radio resource determined as the idle resource in operation S720.

In operation S740, the lending base station 600 may receive an idle resource borrowing message from the borrowing base station 500. According to an aspect, the borrowing base station 500 may select an idle resource to borrow, based on the idle resource information and transmit the idle resource borrowing message to the lending base station 600.

In operation S750, the lending base station 600 may determine whether to lend the idle resource to the borrowing base station 500. According to an aspect, where the lending base station 600 receives an idle resource lending message from a plurality of borrowing base stations 500, the lending base station 600 may determine an amount of idle resources to be lent to each borrowing base station 500.

In operation S760, the lending base station 600 may transmit broadcasting information and a common control signal to the terminal. The lending base station 600 may lend the borrowing base station 500 an idle resource corresponding to a downlink data channel to transmit data to the terminal and an uplink data channel to receive data from the terminal. According to an aspect, the lending base station 600 may not lend the borrowing base station 500 an idle resource corresponding to an access channel to receive an access signal from the terminal. The lending base station 600 may transmit broadcasting information and the common control signal to the terminal using radio resource that is not lent to the borrowing base station 500.

In operation S770, the lending base station 600 may determine whether the access signal is received from the terminal. Also, in operation S770, the lending base station 600 may determine whether there is data to transmit to the terminal positioned in the coverage of the lending base station 600.

Where the access signal is received from the terminal, or where there is data to transmit to the terminal, the lending base station 600 may retrieve the radio resource lent to the borrowing base station 500 and transmit data to the terminal using the retrieved radio resource in operation S780.

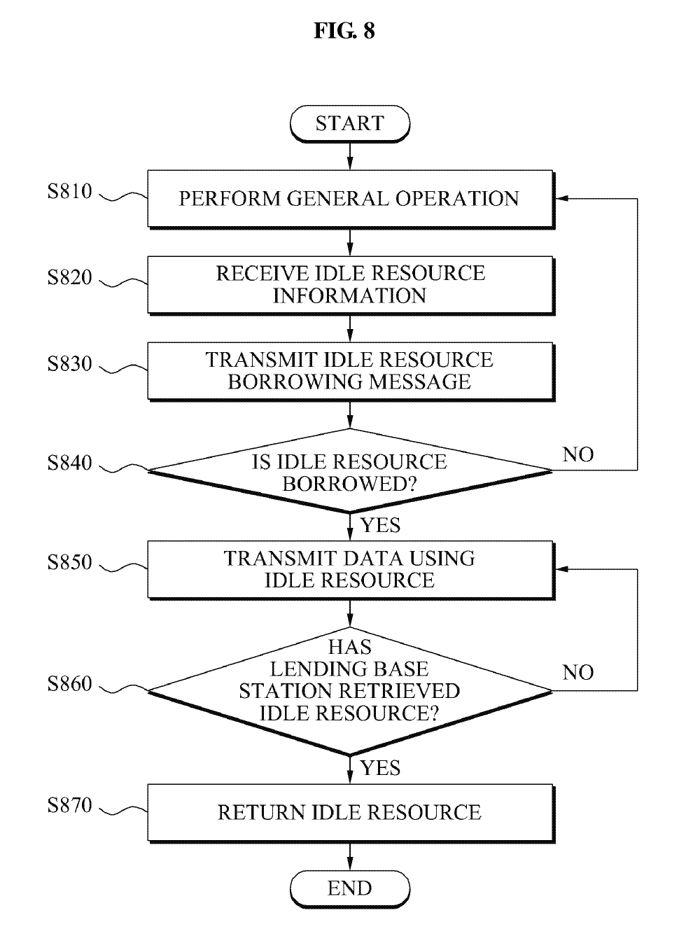

FIG. 8 illustrates an operation of a borrowing base station that receives idle resource information according to an exemplary embodiment. Hereinafter, the operation of the borrowing base station 500 of FIGS. 5 and 6 will be described with reference to FIG. 8.

In operation S810, the borrowing base station 500 may perform a general operation.

In operation S820, the borrowing base station 500 may receive idle resource information from the lending base station 600 of FIGS. 5 and 6. According to an aspect, the idle resource information may include information associated with a radio resource that is not used to perform data transmission or reception among radio resources assigned to the lending base station 600. The borrowing base station 500 may determine an idle resource among the radio resources assigned to the lending base station 600 based on the idle resource information.

According to another aspect, the borrowing base station 500 may sense a base station signal transmitted from the lending base station 600 to determine whether the idle resource exists among the radio resources assigned to the lending base station 600.

In operation S830, the borrowing base station 500 may transmit an idle resource borrowing message to the lending base station 600. According to an aspect, the borrowing base station 500 may select a radio resource to borrow based on idle resource information and generate the idle resource borrowing message based on information associated with the selected radio resource. The idle resource borrowing message may include information associated with the radio resource to borrow.

In operation S840, the borrowing base station 500 may determine whether an idle resource is borrowed from the lending base station 600. According to an aspect, the lending base station 600 may transmit an idle resource lending message to the borrowing base station 500 in response to the idle resource borrowing message. The borrowing base station 500 may determine whether the lending base station 600 lends the idle resource based on the idle resource lending message.

Where the lending base station 600 lends the idle resource to the borrowing base station 500 in operation S840, the borrowing base station 500 may transmit data to a terminal using the idle resource borrowed from the lending base station 600 in operation S850.

In operation S860, the borrowing base station 500 may determine whether the lending base station 600 retrieves a radio resource. According to an aspect, where the borrowing base station 500 receives an idle resource lending terminating message from the lending base station 600, the borrowing base station 500 may determine the lending base station 600 retrieves the radio resource.

In operation S870, the borrowing base station 500 may return the idle resource to the lending base station 600 and suspend data transmission using the idle resource.

FIG. 8 illustrates an example where the borrowing base station 500 receives idle resource information from the lending base station 600. This is only exemplary and embodiments consistent with teachings herein are not limited thereto. For example, the borrowing base station 500 may sense the base station signal received from the lending base station 600 to thereby determine an idle resource of the lending base station.

According to an aspect, a borrowing base station 500 may transmit data using a time frame that includes a control channel and a data channel. A downlink control channel may be used to transmit a common control signal corresponding to a terminal to receive data. A downlink data channel may be used to transmit data that is transmitted to the terminal. Also, a lending base station 600 may receive an access signal from the terminal using an uplink control channel and receive data from the terminal using an uplink data channel. A radio resource corresponding to the data channel is used only where there is data to be transmitted to the terminal, but a radio resource corresponding to the control channel may be used at all times.

According to an aspect, a borrowing base station may detect whether a downlink control channel is included in a base station signal transmitted from a lending base station. The borrowing base station may determine whether radio resource corresponding to the downlink control channel is being used. Where the radio resource corresponding to the downlink control channel is not used, the borrowing base station may determine radio resource corresponding to the control channel and the data channel is not being used, without a need to detect the data channel. In this case, the borrowing base station may transmit an idle resource borrowing message to the lending base station in order to borrow both the control channel and the data channel.

Even in a case where the lending base station does not transmit data to a terminal, a control signal using the control channel may be transmitted. Accordingly, even in a case where the borrowing base station detects the downlink control channel, an additional data channel may be detected. Where the borrowing detects only the downlink control channel and does not detect the downlink data channel, the borrowing base station may determine a radio resource corresponding to the downlink data channel as an idle resource. The borrowing base station may transmit the idle resource borrowing message in order to borrow the radio resource corresponding to the downlink data channel.

Where the borrowing base station detects the control channel of the lending base station, the borrowing base station may determine the lending base station uses both the control channel and the data channel.

According to an aspect, it is possible to manage frequency bands using only a radio resource lending and borrowing relationship between adjacent base stations. Accordingly, there is no need for a centralized radio resource management apparatus.

According to an aspect, it is possible to borrow or lend radio resource between adjacent base stations to thereby effectively manage radio resource without using the centralized radio resource management apparatus. Where radio resource becomes short due to an increase in traffic of a particular base station, the particular base station may borrow a radio resource of an adjacent base station to transmit or receive data.

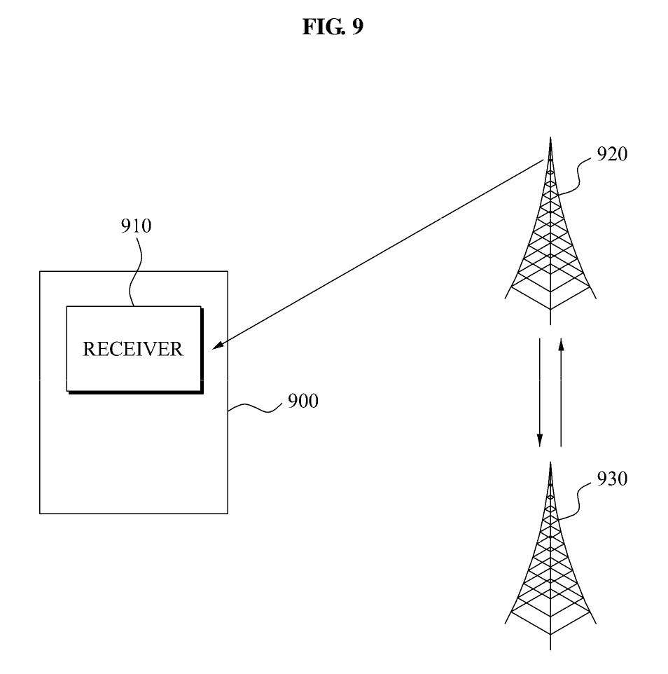

FIG. 9 illustrates a block diagram illustrating a configuration of a terminal 900 that receives, from a borrowing base station 920, data using a data channel of a lending base station 930 according to an exemplary embodiment. Hereinafter, an operation of the terminal 900 will be described in detail with reference to FIG. 9. The terminal 900 may include a receiver 910.

The terminal 900 may access the borrowing base station 920.

The receiver 910 may receive the data from the borrowing base station 920, using the data channel of the lending base station 930.

The borrowing base station 920 may transmit to the lending base station 930, an idle resource borrowing message corresponding to the data channel of the lending base station 930. In response to the idle resource borrowing message, the lending base station 930 may transmit, to the borrowing base station 920, an idle resource lending message that includes information regarding whether to lend the data channel. Where the lending base station 930 does not use the data channel, the lending base station 930 may lend the data channel to the borrowing base station 920.

Where the borrowing base station 920 borrows the data channel of the lending base station 930, the borrowing base station 920 may transmit the data to the terminal 900 using the data channel of the lending base station 930.

According to an aspect, the idle resource denotes a radio resource that is assigned to the lending base station 930, is not currently used by the lending base station 930, and is not lent to the borrowing base station 920. Specifically, the idle resource may include at least one of a frequency band of the data channel of the lending base station 930, a time slot thereof, and an extension code number thereof.

According to an aspect, the lending base station 930 may transmit, to the borrowing base station 920, a base station signal associated with the data channel. The lending base station 930 may receive, from the borrowing base station 920, the base station signal associated with the data channel, and sense the base station signal to determine whether the data channel of the lending base station 930 is the idle resource. According to an aspect, where the borrowing base station 920 does not sense the base station signal of the lending base station 930, the borrowing base station 920 may determine the data channel associated with the base station signal is the idle resource.

According to an aspect, the borrowing base station 920 may measure an amount of interference with respect to the data channel of the lending base station 930. The borrowing base station 920 may transmit, to the lending base station 930, the amount of interference signal and an amount of data to be transmitted from the borrowing base station 920 to the terminal 900. The lending base station 930 may determine whether to lend the idle resource to the borrowing base station 920 based on the amount of transmitted interference signal and the amount of transmitted data.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A borrowing base station apparatus, comprising:
a transmitter to transmit, to a lending base station, an idle resource borrowing message corresponding to a data channel of the lending base station; and
a receiver to receive, from the lending base station in response to the idle resource borrowing message, an idle resource lending message that includes information regarding whether to lend the data channel,
wherein the transmitter transmits data to a terminal using the data channel according to the idle resource lending message.

2. The borrowing base station apparatus of claim 1, wherein the idle resource includes at least one of a frequency bandwidth of the data channel, a time slot thereof, and an extension code number thereof.

3. The borrowing base station apparatus of claim 1, further comprising:
a controller,
wherein the receiver receives idle resource information that includes information regarding whether the data channel is the idle resource, and the controller determines whether to borrow the data channel of the lending base station based on the idle resource information.

4. The borrowing base station apparatus of claim 1, further comprising:
a controller,
wherein the receiver receives, from the lending base station, a base station signal associated with a control channel or the data channel, and the controller senses the base station signal to determine whether the data channel of the lending base station is the idle resource.

5. The borrowing base station apparatus of claim 4, wherein when the controller fails in detecting the control channel based on the sensing result, the controller determines, as the idle resource, a radio resource assigned to a control channel and a data channel corresponding to the base station signal.

6. The borrowing base station apparatus of claim 1, further comprising:
an interference signal measuring unit to measure an amount of interference signal with respect to the data channel,
wherein the transmitter transmits, to the lending base station, an amount of data to be transmitted to the terminal and the amount of interference signal, and the idle resource lending message is generated based on the amount of transmitted data and the amount of transmitted interference signal.

7. The borrowing base station apparatus of claim 1, wherein the data is non-real time data.

8. The borrowing base station apparatus of claim 1, wherein:
the receiver receives an idle resource lending terminating message, and
the transmitter suspends transmission of the data according to the idle resource lending terminating message.

9. A lending base station apparatus, comprising:
a receiver to receive, from a borrowing base station, an idle resource borrowing message with respect to a data channel of a lending base station;
a lending decision unit to determine whether to lend the data channel to the base station; and
a transmitter to transmit an idle resource lending message to the borrowing base station depending on the decision,
wherein the borrowing base station uses the data channel to transmit data to a first terminal.

10. The lending base station apparatus of claim 9, wherein the idle resource includes at least one of a frequency bandwidth of the data channel, a time slot of the data channel, and an extension code number of the data channel.

11. The lending base station apparatus of claim 9, wherein:
the transmitter transmits, to the borrowing base station, idle resource information that includes information regarding whether the data channel is the idle resource, and the idle resource borrowing message is generated based on the idle resource information.

12. The lending base station apparatus of claim 9, wherein:
the transmitter transmits, to the borrowing base station, a base station signal associated with the data channel or a control channel of the lending base station, and
the idle resource borrowing message is generated by sensing the base station signal.

13. The lending base station apparatus of claim 9, wherein:
the receiver receives information associated with an amount of interference signal with respect to the data channel and an amount of data that the borrowing base station transmits to the first terminal, and
the lending decision unit determines whether to lend the idle resource to the borrowing base station based on information associated with the amount of interference signal and the amount of data.

14. The lending base station apparatus of claim 13, wherein:
the receiver receives, from a plurality of borrowing base stations, information associated with an amount of interference signal and an amount of data that each borrowing base station transmits to the first terminal, and
the lending decision unit determines an amount of radio resources to be lent to each borrowing base station to be proportional to the amount of data and inversely proportional to the amount of interference signal.

15. The lending base station apparatus of claim 9, wherein the transmitter transmits, to the lending base station, a lending terminating message with respect to the data channel, and transmits, to the second terminal, data using the data channel.

16. A terminal accessing a borrowing base station, the terminal comprising:
a receiver to receive data from the borrowing base station,
wherein the borrowing base station transmits to a lending base station, an idle resource borrowing message corresponding to a data channel of the lending base station, and
in response to the idle resource borrowing message, the lending base station transmits, to the borrowing base station, an idle resource lending message that includes information regarding whether to lend the data channel, and the data is received using the data channel of the lending base station based on the idle resource lending message.

17. The terminal of claim 16, wherein the idle resource includes at least one of a frequency bandwidth of the data channel, a time slot thereof, and an extension code number thereof.

18. The terminal of claim 16, wherein the borrowing base station receives, from the lending base station, a base station signal associated with a control channel or the data channel, and senses the base station signal to determine whether the data channel of the lending base station is the idle resource.

19. The terminal of claim 16, wherein:
the borrowing base station measures an amount of interference signal with respect to the data channel, and transmits, to the lending base station, an amount of data to be transmitted to the terminal and the amount of interference signal, and
the lending base station generates the idle resource lending message based on the amount of transmitted data and the amount of transmitted interference signal.
